(19) United States
(12) Patent Application Publication
(10) Pub. No.: US 2012/0312712 A1
(43) Pub. Date: Dec. 13, 2012

(54) ROLL OF FLEXIBLE STRIP FOR PRODUCING BAGS

(75) Inventor: Ezequiel GIRO AMIGO, BADALONA (ES)

(73) Assignee: GIRNET INTERNACIONAL, S.L., BADALONA (ES)

(21) Appl. No.: 13/490,672

(22) Filed: Jun. 7, 2012

(30) Foreign Application Priority Data
Jun. 7, 2011 (ES) U 201130630

(51) Int. Cl. B32B 3/10; B65D 30/10; B65D 30/02

(52) U.S. Cl. 206/457; 206/484.1; 428/195.1; 428/172

(57) ABSTRACT

A roll of flexible strip for producing bags, the strip being a strip made of a plastic material suitable for being welded to the body of a tube of plastic fabric or extruded mesh, said strip being wound upon itself longitudinally around a support intended to be coupled to the shaft of a machine, the strip having a repetitive pattern along its length, comprising a functional section and a connecting section contiguous thereto, having a length (L) equal to or greater than the length (l) of the mentioned functional section and having a portion the format of which does not reproduce the format of the mentioned functional section.

### TECHNICAL FIELD OF THE INVENTION

The invention relates to a roll of flexible strip of the type made of a plastic material, intended to be heat welded to the ends of the tubular body of an extruded or fabric mesh for forming a bag closed at its ends. Bags of this type are commonly used for packaging fruit and vegetable products.

### BACKGROUND OF THE INVENTION

Many mesh bag variants comprising a tubular body of extruded or fabric mesh closed at its ends by means of respective welding lines involving at least one strip made of weldable material the ends of which are applied and welded to the mentioned tubular body at the welding areas are known.

Among the previously referred variants, the roll of the invention is applicable, for example, for producing bags comprising a single strip longitudinally applied to one side of the tubular body attaching its bottom with its closed upper end, or also of the type comprising two strips which extend from the bottom of the bag to its upper end, each one applied to one side of the tubular body.

An objective of the present invention is to reduce the material necessary for making bags of this type.

For the purpose of increasing the distinctive feature of the bags, different solutions have additionally been used which, although they do not affect the mechanical properties of the bag, they occasionally increase its cost. The most well known solutions are based on designing the printings made on one of the faces of the strips, which face will be exposed towards the outside once the strip is applied on the tubular body, or even coloring or providing color bands to the mesh itself. Another objective of the invention is therefore to provide the bag with a finish highlighting, for example, its content or origin without it entailing a cost increase of the bag or altering the mechanical properties of the bag.

### DISCLOSURE OF THE INVENTION

For the purpose of finding the technical modification which can solve the aforementioned questions, and starting from the state of the art according to which the strips have a constant width with straight and parallel borders, the inventors have taken advantage of the fact that the strips applied to the sides of the mesh body commonly have a length greater than the length of said body when the bag is full and supported by its upper end. This fact means that in reality, the connecting portion of the strips, which is that extended between the portions which are welded to the bottom and the upper end of the finished bag, does not significantly involve in the tensile strength of said bags.

Taking advantage of this fact, the inventors have determined that this central connecting section can be thinner than its adjacent sections, hereinafter called the functional sections, without it affecting the mechanical properties of the bag. This width reduction of the strip allows a production cost savings of a large series of bags.

The necessary width of the connecting section, due to the design of the illustrations which this section had, similarly and occasionally, determined the width of the functional sections which were oversized; according to the invention the connecting sections can be provided with a maximum width greater than that of the functional sections. Therefore, optimizing the width of the functional sections also affects the production of a large series of bags and the final cost per unit of bag.

The object of the present invention is therefore a roll of flexible strip for producing typical bag packaging, the strip being a strip made of a plastic material suitable for being welded to the body of a tube of plastic fabric or extruded mesh, said strip being wound upon itself longitudinally around a support intended to be coupled to the shaft of a machine.

The roll is essentially characterized in that the strip has a repetitive pattern along its length, comprising a functional section and a connecting section contiguous thereto, having a length L equal to or greater than length l of the mentioned functional section and having a portion the format of which does not reproduce the format of the mentioned functional section.

In a preferred variant, the width Z of the strip in its functional sections being essentially constant, the connecting sections have at least one portion the minimum width z of which is less than the width Z of the mentioned functional sections.

According to another feature of the invention, the contour of the connecting sections follows the silhouette of a figure or graphic composition depicted on one of the faces of the strip; without it affecting the mechanical properties of the bag since the functional sections of the strip will maintain their common dimensions for the intended mechanical purpose and weight.

In one embodiment, the length of the repetitive pattern repeating along the strip is greater than 0.150 m.

According to another feature, the total length of the strip is greater than 500 m.

According to a variant, the contour of the strip is not uniform in its connecting sections and comprises at least one recess the bottom or vertex of which is slightly rounded to prevent strip tearing starting points which are common in materials of this type.

It should be highlighted that the invention proposes a solution which is not only not suggested in the state of the art, but overcomes a certain technical drawback according to which providing an irregular contour to the strips at its edges lead to providing points to the strip which favor starting a break thereof when the bag is held by its upper end. This is one of the reasons why up until now all the bags of the aforementioned type comprise strips having a constant width and parallel and straight edges.

Accordingly, another aspect of the invention is a mesh bag containing products, the bag comprising two segments of strips according to anyone of claims 1 to 6 longitudinally applied on opposite faces of a tube of mesh, the ends of the strips segments being joined to the ends of the tube by means of heat welding.

This bag is essentially characterized in that the ends of the strip segments are functional sections of the strips having a width (Z) essentially constant; in that the functional sections of the strips are connected each other by respective connecting sections having at least one portion the minimum width (z) of which is less than the width (Z) of the mentioned functional sections; and in that the length of the strip segments is selected so that it is greater than the length of the bag when the bag is supported suspended by its upper end.

In one embodiment, the contour of the connecting sections follow the silhouette of a figure or graphic composition depicted on one of the faces of the strips and reproducing the product contained in the bag.

### BRIEF DESCRIPTION OF THE DRAWINGS

FIG. 1 shows a roll of strip according to the invention with its free end partially unwound;

FIG. 2 shows an unwound portion of the strip of a roll according to the invention, comprising three functional sections and two connecting sections;

FIG. 3 is an example of a common bag comprising two strips each applied to one side of the body of the bag, of which only one is visible, the strips having a constant width and straight edges;

FIG. 4 is an example of a bag comprising two strips according to the invention, the connecting section of which has a variable width, including segments having a width less than that of its functional sections welded in the bottom and in the upper end of the bag.

FIG. 5 is another example of a bag comprising two strips according to the invention, in this case the connecting section of which has a constant width which is less than that of its functional sections welded in the bottom and in the upper end of the bag.

### DETAILED DESCRIPTION OF AN EMBODIMENT VARIANT

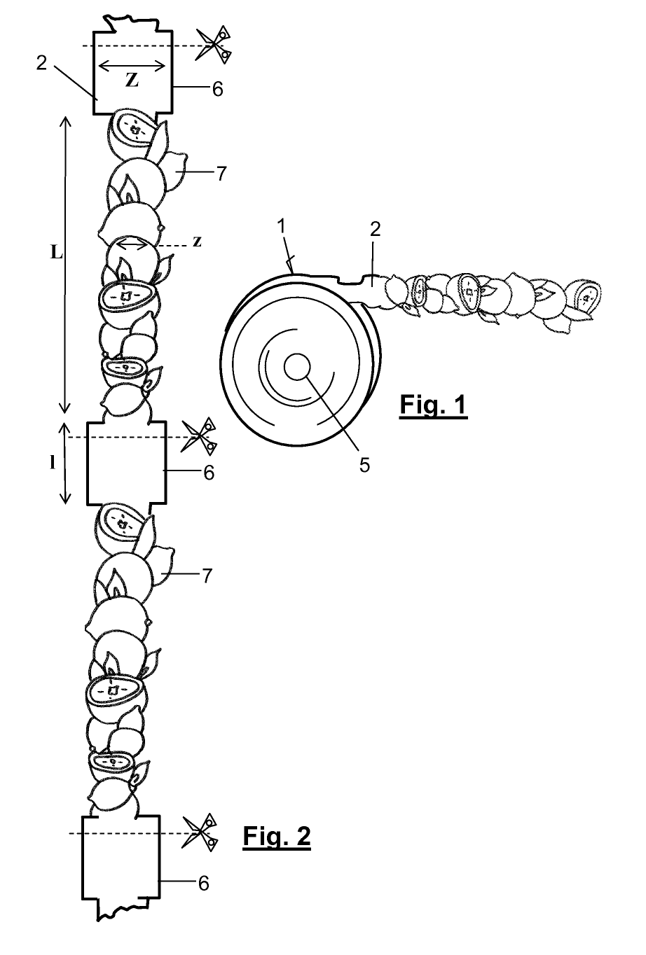

The roll 1 depicted in FIG. 1 is a roll 1 of strip 2 made of a heat weldable plastic material such as polyolefin, suitable to be attached to a longitudinal portion of a tube of mesh 4 (see FIGS. 4 and 5) by means of heat welding. The strip 2 is wound around a hollow tubular support 5 intended to receive the coupling of a shaft of a bag producing and filling machine, for uncoiling/developing the strip 2 on demand.

As seen in FIG. 2, the strip 2 is characterized in that its edges are not straight and parallel along its entire length.

In the example depicted in FIG. 2, the strip 2 has a repetitive pattern along its length comprising a generally rectangular functional section 6 with its straight and parallel edges, and a connecting section 7 contiguous thereto, having a length L greater than the length l of the mentioned functional section 6 and, unlike the latter, does not have straight and parallel edges. The connecting section 7 has a contour which is not uniform and which follows the silhouette of a graphic composition, depicted on one of the faces of the strip 2, based on illustrations of the natural products and particularly based on citrus products.

The strip 2 is especially suitable for forming mesh bags made from a tube of mesh 4, such that the connecting section 7 and functional section 6 each fulfill its function.

More specifically the example strip 2 alternates functional sections 6, having a length l=100 mm and a constant width Z of 90 mm, with connecting sections 7 having a length L=300 mm and a variable width, including sections with a width z significantly less than the constant width Z of the functional section 6.

This strip 2 is especially ideal for bags which must withstand a weight of approximately 2 Kg and the length of which reaches a value somewhat less than 400 mm when they are held, once full, from their upper end.

The strip 2 is also suitable for producing bags with different features by varying the dimensions of the functional and connecting sections. Therefore, bags which can withstand between 0.5 Kg and 5 Kg can be produced using conventional tubes of mesh, even when the connecting sections of the strips have portions with a width less than that of the functional sections, for example, with the adequate selection of length l between 60 and 150 mm; width Z between 50 and 150 mm and length L between 90 and 750 mm.

In the continuous production of a bag 8 of the type as that depicted in FIG. 4, two strips 2 and 2′ are longitudinally applied in a known manner on opposite faces of a tube of mesh 4 such that two consecutive functional sections 6a and 6b coincide with those portions of the tube of mesh 4 from which the upper opening and the bottom of the bag 8 are made.

The assembly formed by the tube of mesh 4 and the strips 2 and 2′ is transversally handled and cut by said functional sections 6a, 6b until obtaining a full bag 8 which is closed at its upper end 9 and lower end 10. At said ends the mesh is arranged between the strips 2 and 2′, which are attached to one another and to the mesh by heat welding, closing the tube of mesh 4 and the full bag adopting the shape depicted in FIG. 4.

It must be noted that the length of each functional section 6 is suitable for each to form the bottom of a bag 8 and to close its upper opening. Possible transverse cut areas of the strip 2 have been depicted in dotted lines in FIG. 2.

The strip 2 will be suitable in the cases in which the length of the connecting section 7 is greater than the length of the tube of mesh 4 when the full bag 8 is held from its upper end 9. In this case, as has been previously explained, the minimum width of this connecting section 7 can be less than the constant width Z recommended for the functional sections 6a and 6b involving in the making of the upper closing and the bottom of the bag 8. This width Z is the determining factor so that the bag can withstand a target weight without breaking. If the strip 2 in this functional section 6 is too thin, the bag 8 can break at its upper end 9 attaching the tube of mesh 4 and the strips 2 and 2′ due to pulling.

The correct use of the strip 2 in producing a bag of the type which allows the connecting sections 7 to be thinner than the functional sections 6. This feature is illustrated in FIGS. 4 and 5 in which it is shown that the mentioned functional sections 7 are thinner than the functional sections 6a and 6b involving in the upper closing and bottom of a bag 8. Whereas in the example of FIG. 4 the connecting section 7 of the strips 2 and 2′ (of which only that of the strip 2 is visible) is not uniform and the edges thereof are not straight or parallel. In the variant of FIG. 5 the edges of the connecting section 7 are straight and parallel, they have a constant width but always less than that of the functional sections 6a and 6b.

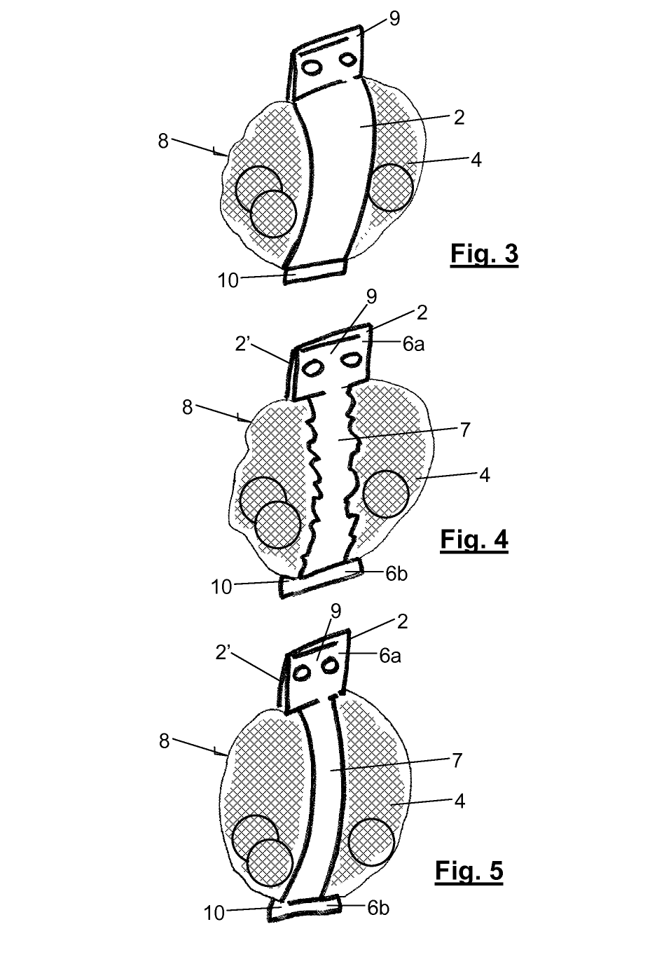

The invention also contemplates that the functional sections 6 can have uneven edges, such as for example in zigzag or with a specific curvature, but it is preferable that they are symmetric and have an essentially constant width so that the longest possible transverse welding and the like can be performed for all the bags which can be obtained from the strip 2. For practical purposes, it is recommendable to continue working with the constant widths Z which are being used in the use of strips 2 having straight and parallel edges along its total length such as those depicted in FIG. 3, and for which a great deal of accumulated experience and the exact measurements suitable for each weight and bag format are already available.

The invention also contemplates that in the connecting sections 7 the strip 2 can adopt a shape which reaches in some section a width greater than that of its functional sections 6, or even that it is provided with perforations, without it affecting the mechanical properties of the finished bag 8 provided that its length is selected according to that which is recommendable.

1. A roll of flexible strip for producing bags, the strip being a strip made of a plastic material suitable for being welded to the body of a tube of plastic fabric or extruded mesh, said strip being wound upon itself longitudinally around a support intended to be coupled to the shaft of a machine, characterized in that the strip has a repetitive pattern along its length, comprising a functional section and a connecting section contiguous thereto, having a length (L) equal to or greater than length of the mentioned functional section and having a portion the format of which does not reproduce the format of the mentioned functional section.

2. The roll according to claim 1, characterized in that the width (Z) of the strip in its functional sections being essentially constant, the connecting sections have at least one portion the minimum width (z) of which is less than the width (Z) of the mentioned functional sections.

3. The roll according to claim 1, characterized in that the contour of the connecting sections follows the silhouette of a figure or graphic composition depicted on one of the faces of the strip.

4. The roll according to claim 1, characterized in that the length of the repetitive pattern repeating along the strip is greater than 150 mm.

5. The roll according to claim 1, characterized in that the total length of the strip is greater than 500 m.

6. The roll according to claim 1, characterized in that the contour of the strip is not uniform in its connecting sections and comprises at least one recess the bottom or vertex of which is slightly rounded to prevent strip tearing starting points.

7. A mesh bag containing products, the bag comprising two segments of strips according to claim 1 longitudinally applied on opposite faces of a tube of mesh, the ends of the strips segments being joined to the ends of the tube by means of heat welding, characterized in that said ends of the strip segments are functional sections of the strip having a width (Z) essentially constant; in that the functional sections of the strips are connected each other by respective connecting sections having at least one portion the minimum width (z) of which is less tan the width (Z) of the mentioned functional sections; and in that the length of the strip segments is selected so that it is greater than the length of the bag when the bag is supported suspended by its upper end.

8. A mesh bag according to claim 1, characterized in that the contour of the connecting sections follow the silhouette of a figure or graphic composition depicted on one of the faces of at least one strip and reproducing the product contained in the bag.
